(19) United States
(12) Patent Application Publication
(10) Pub. No.: US 2018/0249195 A1
(43) Pub. Date: Aug. 30, 2018

(54) METHOD AND DEVICE OF DOWNLOADING VIDEO AND AUDIO FILE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Guannan YAN, Beijing (CN); Zhongbin TONG, Beijing (CN)

(21) Appl. No.: 15/244,956

(22) PCT Filed: Jun. 24, 2016
(86) PCT No.: PCT/CN2016/087069

§ 371 Date: Aug. 23, 2016

(30) Foreign Application Priority Data
Nov. 23, 2015 (CN) 201510818478.X

(51) Int. Cl. H04N 21/262; H04N 21/458

(52) U.S. Cl. CPC H04N 21/26291; H04N 21/4586

(57) ABSTRACT

The embodiments of the present disclosure provide a downloading method and system of video and audio file. The method comprises the steps of receiving the video and audio file information from the first terminal, setting the acquiring clock of the video and audio file information according to the update information therein and downloading the updated episodes according to the acquiring clock. According to the embodiments of the present disclosure, the episode tracking operation time is shortened without artificial participation; meanwhile, the chance of missing the episode update is further avoided without artificial participation.

### CROSS-REFERENCE TO RELATED APPLICATIONS

The present disclosure is a continuation of International Application No. PCT/CN2016/087069, which is based upon and claims priority to Chinese Patent Application No. 201510818478.X, entitled “METHOD AND SYSTEM OF DOWNLOADING VIDEO AND AUDIO FILE”, filed to State Intellectual Property Office of The P.R.C on Nov. 23, 2015, the entire contents of which are incorporated herein by reference.

### FIELD OF TECHNOLOGY

The present disclosure generally relates to a technical field of data downloading, and particularly relates to a method and device of downloading a video and audio file.

### BACKGROUND

At present, abundant film and television programs are available in the Internet, particularly film and television episodes emerging in endlessly. However, the majority of relatively new film and television episodes are not all issued to the Internet at the same time but are issued in a form of updating the episodes at fixed time every day or every week, so that the behavior that a user calculates the episode updating time in front of a television or a computer to wait for the episode to play is born. The behavior is called episode tracking.

A conventional episode tracking mode is that the user opens an online play application program of film and television programs every day or every week to search for the tracked film and television programs and select the updated episodes to download or play online. Frequent operation every day or every week is redundant and tedious and the operating process wastes time.

If the updated episodes are downloaded to a terminal of the application program to be stored, the updated episodes are further limited by the storage space of the terminal.

### SUMMARY

The embodiments of the present disclosure discloses a method and device of downloading video and audio file for solving the problem that the conventional episode tracking mode is redundant and tedious as a result of frequent operation and needs artificial participation and the operating process wastes time.

According to one aspect of the present disclosure, the embodiments of the present disclosure provide a method of downloading a video and audio file, including: receiving video and audio file information from a first terminal, wherein the video and audio file information comprises update information of the video and audio file; setting an acquiring clock for the video and audio file according to the update information of the video and audio file; downloading the updated video and audio file according to the acquiring clock.

Correspondingly, according to another aspect of the present disclosure, the embodiments of the present disclosure further provide a device of downloading video and audio file, including: at least one processor; and a memory communicably connected with the at least one processor for storing instructions executable by the at least one processor, wherein execution of the instructions by the at least one processor causes the at least one processor to:
receive video and audio file information from the first terminal, wherein the video and audio file information includes update information of video and audio file;
set acquiring clock for the video and audio file according to the update information of the video and audio file;
download the updated video and audio file according to the acquiring clock.

Correspondingly, according to still another aspect of the present disclosure, there is disclosed an electronic device including: one or more processors; a memory and/or one or more modules, the modules are stored in the memory and are configured to be processed by one or more processors, wherein the modules are configured to execute the methods above.

Correspondingly, according to still another aspect of the present disclosure, there is disclosed a computer readable medium, which stores the computer program for executing the methods above.

According to the downloading method and device of video and audio file provided by the embodiments of the present disclosure, video and audio file information is acquired through the first terminal. The video and audio file information includes the update information of the tracked episodes. The method includes the steps of receiving the video and audio file information from the first terminal, setting the acquiring clock for the video and audio file information according to the update information therein and downloading the updated episodes according to the acquiring clock. The episode tracking operation time is shortened without artificial participation; meanwhile, the chance of missing the episode update is further avoided without artificial participation.

The above description is only the summary of the technical scheme of the present disclosure. In order to understand the technical means of the present disclosure more clearly to implement the technical means according to the content of the description, and to make the above and other purposes, characteristics and advantages of the present disclosure more obvious and understandable, description of the embodiments of the present disclosure are listed as follows.

### BRIEF DESCRIPTION OF THE DRAWINGS

In order to depict the technical scheme in the embodiments of the present disclosure more clearly, the drawings needed to be used in the embodiments of the present disclosure are simply introduced. It is obvious that the drawings in the description are some embodiments of the present disclosure. As far as ordinary technical staff in the field is concerned, on the premise of not contributing creative labor, other drawings can be further obtained according to the drawings.

FIG. 1 is a flow chart of a method of downloading a video and audio file according to a first embodiment of the present disclosure.

FIG. 2 is a structural schematic diagram of a device of downloading video and audio file according to a second embodiment of the present disclosure.

FIG. 3 schematically shows a block diagram of the terminal for executing the method according to the present disclosure.

FIG. 4 schematically shows a storage unit for keeping or carrying a program code, which implements the method according to embodiments of the present disclosure.

### DESCRIPTION OF THE EMBODIMENTS

In order to make the purpose, technical scheme and advantages of the embodiments of the present disclosure more clear, the technical scheme according to the embodiments of the present disclosure are clearly and integrally described by combining the drawings in the embodiments of the present disclosure. Obviously, the described embodiments are part of embodiments of the present disclosure rather than all the embodiments. Based on the embodiments of the present disclosure, all the other embodiments obtained by the ordinary technical staff in the field on the premise of not contributing creative labor shall fall into the scope of the present disclosure.

### First Embodiment

A method of downloading a video and audio file provided by the first embodiment of the present disclosure is introduced in detail, which may be applied to the second terminal. The second terminal is connected with the first terminal, and the first terminal may acquire the video and audio file information (information of to-be-tracked episodes).

With reference to the FIG. 1, it is a flow chart showing the method of downloading a video and audio file according to the first embodiment of the present disclosure.

Step 100, receiving the video and audio file information from the first terminal.

The first terminal may be installed with the application program for acquiring the video and audio information and acquires the video and audio file information through the application program, and the video and audio file information is information carried by the video and audio file; furthermore, the storage space of the first terminal smaller than that of the second terminal is unfavorable for downloading the video and audio file, so that the video and audio file information is received from the first terminal while the video and audio file are downloaded locally from the second terminal. The first terminal may be connected with the second terminal in a wired mode and may be further connected with the second terminal in a wireless mode. The embodiments of the present disclosure do not limit the specific connecting modes between the first terminal and the second terminal. The first terminal can be mobile equipment such as an intelligent mobile and a tablet personal computer; the second terminal can be a net box with a bulk-storage memory space, an intelligent router with a bulk-storage memory space and the like, wherein the bulk-storage memory space of the net box or the intelligent router can be built-in or external.

The video and audio file information can include the update information of the video and audio file. The video and audio file according to the embodiments of the present disclosure may be film and television episodes including a plurality of episodes, wherein each episode is periodically updated and launched.

In an optional embodiment of the present disclosure, the video and audio file information may further include brief introduction information of the video and audio file and the downloading information of the video and audio file, wherein the downloading information of the video and audio file may be the downloading information of each episode, which is issued, of the film and television episodes. Not only may the updated episodes be downloaded, but also the previous episodes may be downloaded by recording the downloading information of each episode that is issued.

In an optional embodiment of the present disclosure, the video and audio file information from the first terminal may be information relevant to the video and audio file, which is recorded by the application program in the first terminal as a confirmed video and audio file. The first terminal may be installed with the application program. In the application program, the video and audio file that may be downloaded or played in the Internet can be displayed. One or more of the video and audio file are selected from the numerous video and audio file to be tracked.

Step 102, setting an acquiring clock for the video and audio file according to the update information of the video and audio file.

The update information of the video and audio file may include one or more update time points of the video and audio file. For example, some film and television episodes includes 20 episodes, wherein each episode is updated at 22:00 every Monday, so that the film and television episodes may include 20 update time points, which are 22:00 Monday.

The step 102 may specifically be setting one or more acquiring clock corresponding to the one or more update time points. The quantity of the update time points is equal to that of the acquiring clock, that is, the update time points are in one-to-one correspondence with the acquiring clock. If some update time point is 22:00, Monday: 1, Nov., 2016, the acquiring clock of the update time point is set as 22:00, Monday: 1, Nov., 2016.

In an embodiment of the present disclosure, the update information of the video and audio file may further include update frequency. For example, some film and television episodes totally include 20 episodes, wherein each episode is updated at 22:00 every Monday, so that the update frequency of the film and television episodes is one week. After the issuing time of the first episode of the film and television episodes is determined, the update time of other each episode may be determined according to the update frequency. Further, the acquiring clock for the video and audio file is set according to the update frequency of the video and audio file; after the issuing time of the first episode of the film and television episodes is determined, the update time of other each episode may be determined according to the update frequency; the acquiring clock may be set according to the update time of each episode.

Step 104, downloading the updated video and audio file according to the acquiring clock.

If the current time reaches the time represented by any one of the acquiring clocks, the updated video and audio file corresponding to the reached acquiring clock of the current time are downloaded. The current time can be the system time of the second terminal.

Downloading the updated video and audio file corresponding to the reached acquiring clock of the current time may specifically be receiving a uniform resource locator from the first terminal, and downloading the updated video and audio file corresponding to the reached acquiring clock of the current time by using the uniform resource locator.

The first terminal may acquire the uniform resource locator corresponding to the updated video and audio file and send the uniform resource locator to the second terminal; the second terminal may also directly acquire the uniform resource locator corresponding to the updated video and audio file.

In an optional embodiment of the present disclosure, after the step 104, the downloading state of the updated video and audio file may be further sent to the first terminal.

The downloading state may include an unloaded state, an unloading state, a loaded state and the like. The specific downloading progress may be displayed in downloading in form of percentage. By sending the downloading states to the first terminal, the downloading condition of the updated video and audio file may be mastered at the first terminal. As equipment for downloading and storing the video and audio file, the second terminal is larger than the first terminal in storage capacity, but the second terminal that is often relatively large in volume and weight is inconvenient to carry. By downloading the video and audio file in the second terminal, the problem that the storage space of the first terminal is tight is solved.

In conclusion, according to the technical scheme provided by the embodiments of the present disclosure, video and audio file information is acquired through the first terminal. The video and audio file information includes the update information of the tracked episodes. The method includes the steps of receiving the video and audio file information from the first terminal, setting the acquiring clock for the video and audio file information according to the update information therein and downloading the updated episodes according to the acquiring clock. The episode tracking operation time is shortened without artificial participation; meanwhile, the chance of missing the episode update is further avoided without artificial participation.

### Second Embodiment

Detailed introduction of a downloading system of video and audio file provided by the second embodiment of the present disclosure is as follows.

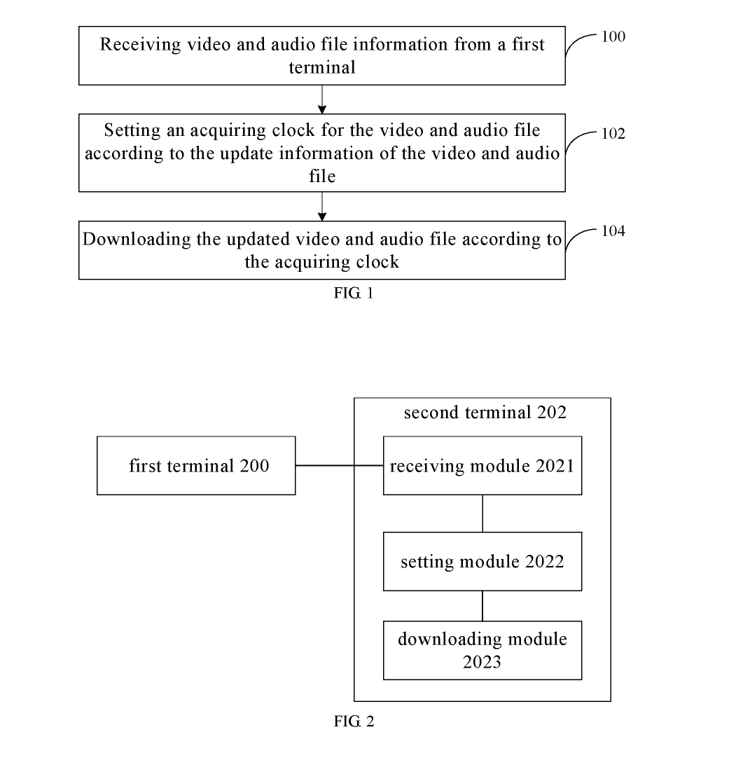

With reference to the FIG. 2, a structural schematic diagram of the downloading system of video and audio file according to a second embodiment of the present disclosure is depicted.

The system includes a first terminal 200 and a second terminal 202, wherein the first terminal 200 is connected with the second terminal 202. The second terminal 202, which is taken as a downloading device of video and audio file, includes a receiving module 2021, a setting module 2022 and a downloading module 2023.

The functions of the modules and the relationships among the modules are introduced below in detail, respectively.

The receiving module 2021 is used for receiving video and audio file information from the first terminal 200, wherein the video and audio file information includes update information of video and audio file.

The video and audio file information from the first terminal 200 may be relevant information of the video and audio file, which is recorded by the application program as a confirmed video and audio file in the first terminal 200.

The video and audio file information may further include brief introduction information of the video and audio file and the downloading information of the video and audio file.

The setting module 2022 is used for setting acquiring clock for he video and audio file according to the update information of the video and audio file.

The update information of the video and audio file may include one or more update time points of the video and audio file.

The setting module 2022 is used for setting one or more acquiring clock corresponding to the one or more update time points.

The downloading module 2023 is used for downloading the updated video and audio file according to the acquiring clock.

The downloading module 2023 may download the updated video and audio file corresponding to the reached acquiring clock of the current time when the current time reaches the time represented by any one of the acquiring clocks.

Optionally, the downloading module 2023 receives a uniform resource locator from the first terminal 200, and downloads the updated video and audio file corresponding to the reached acquiring clock of the current time by using the uniform resource locator.

Optionally, the second terminal 202 may further include:
a synchronizing module for sending the downloading state of the updated video and audio file to the first terminal 200 after the downloading module 2023 downloads the updated video and audio file according to the acquiring clock.

Each of devices according to the embodiments of the disclosure may be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

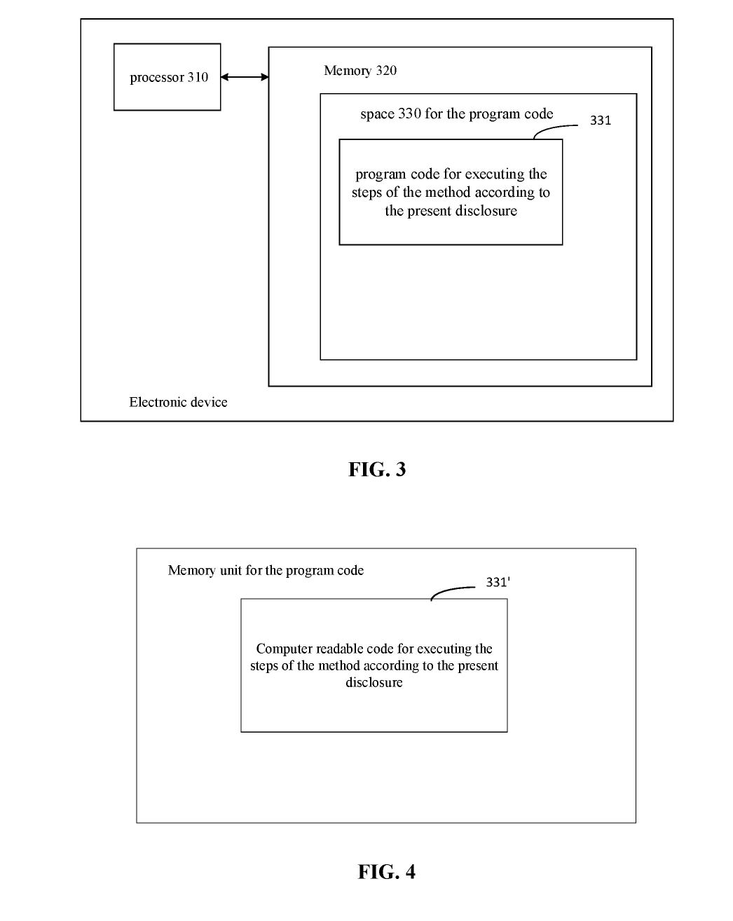

For example, FIG. 3 illustrates a block diagram of an electronic device for executing the method according the disclosure. Traditionally, the electronic device includes a processor 310 and a computer program product or a computer readable medium in form of a memory 320. The memory 320 could be electronic memories such as flash memory, EEPROM (Electrically Erasable Programmable Read-Only Memory), EPROM, hard disk or ROM. The memory 320 has a memory space 330 for executing program codes 331 of any steps in the above methods. For example, the memory space 330 for program codes may include respective program codes 331 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 4. The memory cells may be provided with memory sections, memory spaces, etc., similar to the memory 320 of the server as shown in FIG. 3. The program codes may be compressed for example in an appropriate form. Usually, the memory cell includes computer readable codes 331′ which can be read for example by processors 310. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

In conclusion, according to the technical scheme provided by the embodiments of the present disclosure, video and audio file information is acquired through the first terminal. The video and audio file information includes the update information of the tracked episodes. The method includes the steps of receiving the video and audio file information from the first terminal, setting the acquiring clock for the video and audio file information according to the update information therein and downloading the updated episodes according to the acquiring clock. The episode tracking operation time is shortened without artificial participation; meanwhile, the chance of missing the episode update is further avoided without artificial participation.

The depicted embodiments of the device are only schematic. The units depicted as separated parts can be or cannot be physically separated. The parts displayed as units can be or cannot be physical units, that is, the parts can be located in a same place, or further can be distributed to a plurality of network units. Part of or all of the modules can be selected according to actual demand to realize the purpose of the embodiment. The ordinary technical staff in the field can understand and implement the embodiment on the premise of not contributing creative labor.

Finally, it should be noted that the embodiments are only used for illustrating the technical scheme of the present disclosure rather than limiting the technical scheme. In spite of illustrating the present disclosure in detail with reference to the embodiments, the ordinary technical staff in the field should understand that the ordinary technical staff in the field still can modify the technical scheme recorded in the embodiments or perform equivalent replacement on part of technical characteristics therein. It will be appreciated that those modifications or variations of the present disclosure do not make the essence of the corresponding technical scheme depart from the spirit or scope of the present disclosure.

What is claimed is:

1. A method of downloading a video and audio file, which is applied by an electronic device, comprising:
receiving video and audio file information from a first terminal, wherein the video and audio file information comprises update information of the video and audio file;
setting an acquiring clock for the video and audio file according to the update information of the video and audio file;
downloading the updated video and audio file according to the acquiring clock.

2. The method according to claim 1, wherein the video and audio file information from the first terminal is information relevant to the video and audio file which is recorded by the application program in the first terminal as a confirmed video and audio file, wherein the video and audio file information further comprises brief introduction information of the video and audio file and downloading information of the video and audio file.

3. The method according to claim 1, wherein the update information of the video and audio file comprises one or more update time points of the video and audio file; and
the setting an acquiring clock for the video and audio file according to the update information of the video and audio file comprises:
setting one or more acquiring clocks corresponding to the one or more update time points.

4. The method according to claim 3, wherein downloading the updated video and audio file according to the acquired clock comprises:
downloading the updated video and audio file corresponding to the reached acquiring clock of the current time if the current time reaches the time represented by any one of the acquiring clocks.

5. The method according to claim 4, wherein downloading the updated video and audio file corresponding to the reached acquiring clock of the current time comprises:
receiving a uniform resource locator from the first terminal, and downloading the updated video and audio file corresponding to the reached acquiring clock by using the uniform resource locator.

6. The method according to claim 1, wherein after downloading the updated video and audio file according to the acquired clock, the method further comprises:
sending a downloading state of the updated video and audio file to the first terminal.

7. An electronic device, comprising:
at least one processor; and
a memory communicably connected with the at least one processor for storing instructions executable by the at least one processor, wherein execution of the instructions by the at least one processor causes the at least one processor to:
receive video and audio file information from a first terminal, wherein the video and audio file information comprises update information of the video and audio file;
set an acquiring clock of the video and audio file according to the update information of the video and audio file;
download the updated video and audio file according to the acquiring clock.

8. The electronic device according to claim 7, wherein the video and audio file information from the first terminal is information relevant to the video and audio file which is recorded by the application program in the first terminal as a confirmed video and audio file, wherein the video and audio file information further comprises brief introduction information of the video and audio file and downloading information of the video and audio file.

9. The electronic device according to claim 7, wherein the update information of the video and audio file comprises one or more update time points of the video and audio file;
the set acquiring clock for the video and audio file according to the update information of the video and audio file comprises: set one or more acquiring clock corresponding to the one or more update time points.

10. The electronic device according to claim 9, wherein download the updated video and audio file according to the acquired clock comprises: download the updated video and audio file corresponding to the reached acquiring clock of the current time if the current time reaches the time represented by any one of the acquiring clocks.

11. The electronic device according to claim 10, wherein download the updated video and audio file corresponding to the reached acquiring clock of the current time comprises:
receive a uniform resource locator from the first terminal, and download the updated video and audio file corresponding to the reached acquiring clock by using the uniform resource locator.

12. The electronic device according to claim 7, wherein further, execution of the instructions by the at least one processor causes the at least one processor to:
send a downloading state of the updated video and audio file to the first terminal after download the updated video and audio file according to the acquiring clock.

13. A non-transitory computer readable medium having computer programs stored thereon that, when executed by one or more processors of an electronic device, cause the electronic device to perform:
receive video and audio file information from a first terminal, wherein the video and audio file information comprises update information of the video and audio file;
set an acquiring clock for the video and audio file according to the update information of the video and audio file;
download the updated video and audio file according to the acquiring clock.
